(19) United States
(12) Patent Application Publication
(10) Pub. No.: US 2006/0034460 A1
(43) Pub. Date: Feb. 16, 2006

(54) Method and system of forecasting

(76) Inventors: Bernardo Huberman, Palo Alto, CA (US); Tad Hogg, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/915,254

(22) Filed: Aug. 10, 2004

Related U.S. Application Data
(63) Continuation-in-part of application No. 10/685,617, now abandoned.

(51) Int. Cl. H04L 9/00

(52) U.S. Cl. 380/277

(57) ABSTRACT

A forecasting system comprises a plurality of forecasters that provide predictions and that have individual identities. A plurality of users depend on receiving the predictions from the forecasters and use forecasts assembled there from to manage a business organization. An encryption system encodes and hides the individual identities of each of the plurality of forecasters and thereby encourages more honest predictions. A decryption system decodes and reveals the individual identities of each of the plurality of forecasters and discourages moral hazards in the predictions. The individual identities of each of the plurality of forecasters are encrypted, associated, and embedded with their respective predictions.

### RELATED APPLICATIONS

This application is a continuation-in-part of patent application Ser. No. 10/685,617 entitled “A Method for Avoiding Moral Hazards in Organizational Forecasting” filed Oct. 15, 2003.

### FIELD OF THE INVENTION

The present invention relates to forecasting, and more particularly to automation for forecasting the outcome of uncertain situations while avoiding conflicts of interests.

### BACKGROUND OF THE INVENTION

Predicting future trends is an important task for almost all organizations. In order to make strategic decisions and plan for uncertain situations an organization will require a methodology and tool for forecasting that of the various possible outcomes is most likely. Forecasting of this type is required in a wide range of situations including production planning, evaluating technology, assessing the state of a market. As a result, a great deal of time and money is spent in these forecasts.

Committees of experts or consultants, and statistical inference techniques are conventional. More recently, information is treated as an asset that can be traded within a market in the form of state contingent securities. Such techniques have been found to be relatively accurate when compared to the traditional methods of predicting outcomes in uncertain situations.

U.S. patent application, U.S. 2003/0078829 A1, by Chen et al., describes predicting future outcomes using an information market in which predictions for a group of forecaster's are accumulated with adjustments that account for each individual participants characteristics. But such does not address the problem that those directly involved in predicting future outcomes used in a forecast will have a conflict of interest in participating in the forecasting process.

In general, a conflict of interest exists in a situation in which an individual is making a prediction about an uncertain outcome and they can personally benefit by their prediction. An ethical line is crossed if they influence the actual outcome that is the subject of the prediction.

Clearly in this situation the individual can influence the outcome to try and attain their prediction in order to receive the reward for accurate prediction. If an individual's prediction is higher than predicted by others the conflict of interest situation can have positive affects, in which in order for the company or organization to meet the predicted outcome the organization is pushed to work harder or more efficiently. On the other hand when the individual has made a pessimistic forecast they may relax their standards and slow production or take other detrimental action so as to meet their prediction. A conflict of interest of this type is often termed a moral hazard.

Another pervasive problem in a real world situation that influences the success of any predictive tool is the willingness for people to participate in the prediction process. In a situation in which either a perceived or real moral hazard situation is likely to occur, participation in forecasting is less likely. Moreover the stigma associated with publicly making negative predictions about ones colleagues or workers may be a further disincentive to participate in forecasting activities.

### SUMMARY OF THE INVENTION

Briefly, a forecasting system embodiment of the present invention comprises a plurality of forecasters that provide predictions and that have individual identities. A plurality of users depend on receiving the predictions from the forecasters and use forecasts assembled there from to manage a business organization. An encryption system encodes and hides the individual identities of each of the plurality of forecasters and thereby encourages more honest predictions. A decryption system decodes and reveals the individual identities of each of the plurality of forecasters and discourages moral hazards in the predictions. The individual identities of each of the plurality of forecasters are encrypted, associated, and embedded with their respective predictions.

### BRIEF DESCRIPTION OF THE DRAWINGS

FIG. 1 is a functional block diagram of a computer system embodiment of the present invention for generating forecasts;

FIG. 2 is a flowchart diagram of a forecasting process embodiment of the present invention;

FIG. 3 is a flowchart diagram of another forecasting process embodiment of the present invention;

FIG. 4 is a dataflow diagram of an identity escrow embodiment of the invention in which the entities are all members of the production group;

FIG. 5 is a dataflow diagram of an alternative identity escrow scheme that can be used wherein the entities include the members of the production group and the organization for that the forecasts are being provided;

FIG. 6 is a graph of the equilibrium states for participation and defection in respect of forecasting and production that can be used to optimize the design choices available when implementing a method according to the present invention; and

FIG. 7 is a graph similar to that of FIG. 6 but for an alternative embodiment of the invention.

### DETAILED DESCRIPTION OF THE EMBODIMENTS

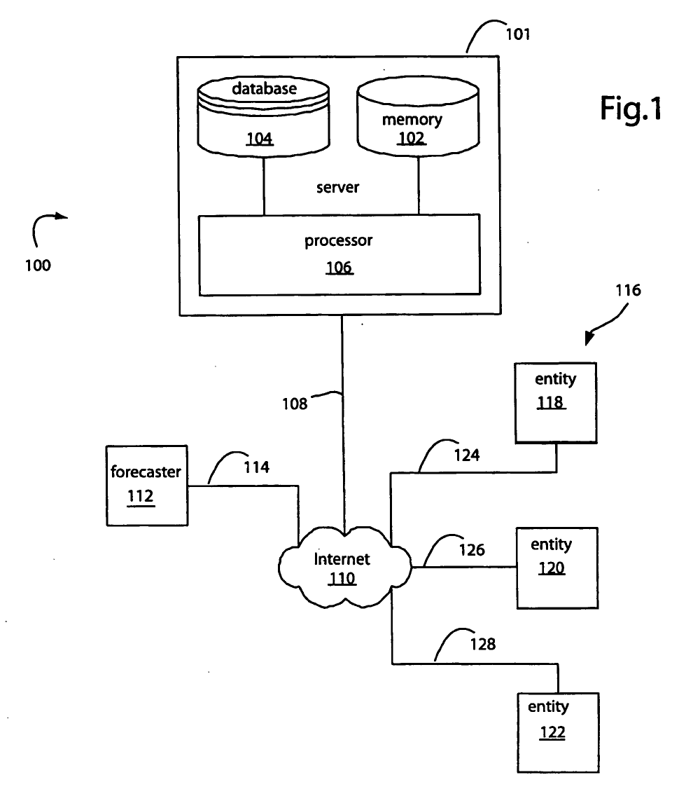

A forecasting embodiment of the present invention maybe implemented by software hosted on a computer system and network. An exemplary forecast network 100 is shown in FIG. 1. Embodiments of the present invention provide forecasts based on anonymous forecasting and enable group detection of bias. The anonymous forecasting encourages legitimate forecasting of negative outcomes, and such group detection of bias reduces the likelihood that a forecaster could run amok. Conditional anonymity is provided to each forecaster. The relative privacy offered by the process enables pessimistic forecasts to be made without incurring a social cost associated with announcing a pessimistic forecast, whilst the threat of a loss of privacy deters the establishment of detrimental conflicts of interest.

The forecasting network 100 includes a server 101 with a memory 102, a database 104, and a processor 106. In use, the processor 106 is configured to run a forecasting application program that is loaded into the computer memory 102. Computer memory 102 stores forecast data and other data generated by or received by the computer system. Memory 104 has stored therein one or more database structures for storing data created by the processor 106 and received from forecasters or entities, including forecast data, encryption data, decryption keys or decryption elements.

Server 101 networks through a connection 108 to the Internet or other computer network 110. A forecaster 112 is connected to network 110 by communications link 114, and a group 116 of entity systems 118, 120, and 122 are connected to the network 110 by respective communication links 124, 126, and 128.

A business organization needing forecasting may be hierarchically organized into production groups of various sizes. Each production group typically has a designated person associated with it that provides a prediction for the output of the production group. Often, this forecaster is the group manager or one of the members of the production group. In certain organizations, more than one person may make predictions for the output of the production group.

For example, forecaster 112 is associated with a organization production group to enter forecast data and forward it to server 101. The forecaster 112 runs an application program that allows data communication with server 101, e.g., Internet browser application communicating with a webpage hosted on server 101. Alternatively, the application program running on the forecaster system 112 may be a dedicated application that allows entry of predictions in accordance with a predetermined data format for transmission to server 101.

Each of the members, or entities, of the production group can access any one of the entity systems group 116. These each include an application program that allows data to be exchanged with server 101, such as an Internet browser. A webpage on server 101 allows a production group member to submit a request to server 101 for forecast data. The webpage may be implemented in the form of an on-line form that contains data entry fields that enable the entity to enter text identifying a suspect forecast or forecaster.

The organization's management uses forecasts for strategic business planning. If a moral hazard is suspected, e.g., a conflict of interest, a request may be made to server 101. Entity systems 118, 120, and 122 can ask for forecasting details including the specific identity of the forecasters. Otherwise, the forecasters' identities are concealed to encourage candid and honest forecasts.

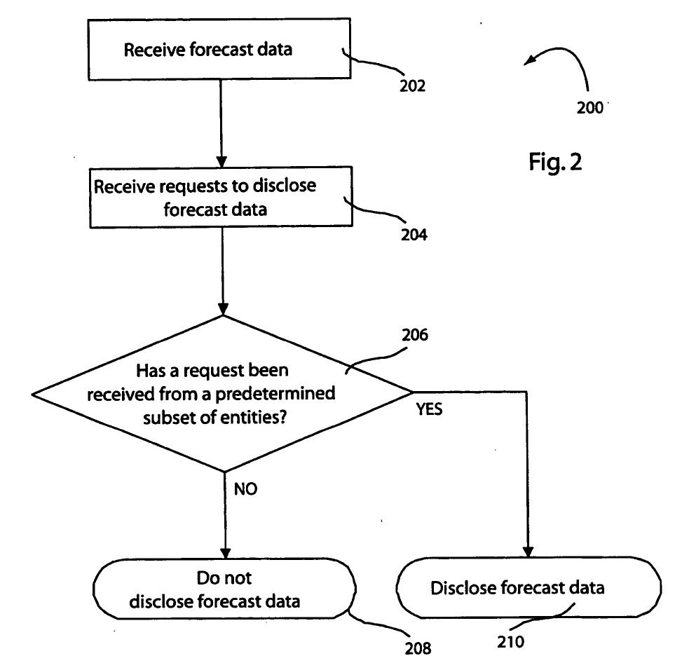

FIG. 2 represents a forecasting process embodiment of the present invention, and is referred to herein by the general reference numeral 200. Process 200 includes a step 202 in which, e.g., server 101 (FIG. 1) receives a prediction from a forecaster. Typically, such will be in response by forecasters 112 to a web-page being sent asking them to predict something, e.g., the production output of their respective production group for the next month. For simplicity, forecasting network 100 in FIG. 1 is shown as only having one forecaster 112. Each forecaster 112 responds by transmitting a prediction, the forecaster's identity, and any comments. Many forecasters will provide individual forecast data.

The predictions received for each production group are accumulated into a single global prediction. These are stored, e.g., in database 104, for later broadcast to the organization. The reporting of forecasts is done anonymously. The organization does not know which of the received forecasts relates to that production group, and consequently which forecaster made such prediction. In this way, the organization gets the benefit of the forecasting procedure, and the individuals do not risk some of the stigma that could occur if reporting negative feedback to their superiors.

Once the forecast data has been received by the computer system and production or other organizational activities are underway that is aimed at achieving an outcome in relation to the uncertain situation, there is the possibility that one or more members of the production group will suspect that the forecaster for their production group has provided a negative forecast for the group and is attempting to influence the operation of the group to meet their prediction.

In a step 204, the members of the production group can submit a request to disclose a forecaster's identity if a moral hazard is suspected. An interactive webpage or application program can be used to make such a request. A step 206 asks if the request to disclose has come from a proper subgroup of users. If not, control passes to a step 208. Otherwise, the requested disclosure in made in a step 210.

In most implementations the members of the production group will know who makes the forecasts for their group, so such forecasting is not anonymous. However, when the forecasting is secret, the production group is not told the forecast made in relation to their group. They must detect a moral hazard from the behavior, without knowing the prediction.

In step 206, the processor determines if requests to disclose forecast data have been received from a subgroup of the members of the production group, indicating that they suspect a moral hazard. A moral hazard is more likely when the number of requests received in step 204 is high. The subgroup may include a variety of members of the organization, the production group, etc.

In a one embodiment, threshold cryptography is used to conditionally protect the forecast data. The forecast data, the forecaster's identity, and predictions, are encrypted by the processor using a public key and stored, e.g., in the database 104 (FIG. 1). A private key is required to decrypt the forecast data and disclose the forecaster's identity and prediction.

In threshold cryptography, the private key is divided into several pieces. Each key part is distributed to various individuals in a subgroup. Here in this example, a piece of the private key associated with each of the members of the production group is stored in database 104. When a request is received from an individual, a piece of the whole private key is provided to the processor to use in the decryption process. At least k number of pieces are required to reconstruct a whole private key. If their are k pieces, the identity of the person who made the suspicious prediction will become accessible.

Embodiments of the present invention are such that when a sufficient number of requests for disclosure have been received, there will be sufficient decryption key segments to be able decrypt the forecast data.

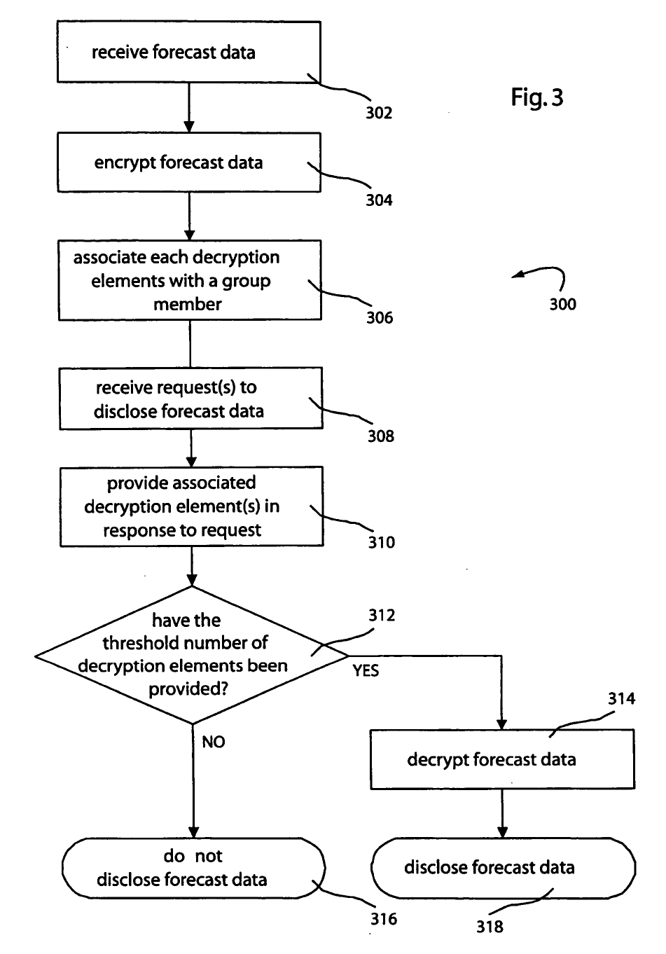

A method embodiment of the present invention is illustrated in FIG. 3, and is referred to herein by the general reference numeral 300 Method 300 begins with a step 302 in which forecast data is received and stored. Such data includes a forecast and an encrypted payload. The forecaster's identity is included in the encrypted payload and is accessible when a threshold number of private key segments are on hand to unlock it. A step 304 encrypts the forecast data. A step 306 associates each of the private key segments with a corresponding group member. A minimum number of these private key segments will need to be gathered together later to decrypt the encoded data if that becomes necessary. Until decrypted, the forecasts related to the encrypted forecast data are publicly accessible and anonymous.

In a particular embodiment, the decryption elements are stored in the database. Such are forwarded to the processor for use in decryption after a request is received from the entity associated with a key. Alternatively, the decryption elements can be transmitted to the entity systems. In such an implementation, a request to disclose forecast data includes transmission of a decryption element to the computer system.

Next, in a step 308, the requests to disclose forecast data are received from the entities within the group. In a step 310, the processor is provided with the corresponding decryption elements in response to the received requests. The decryption elements can be provided from the database, or as part of the request data. In an alternative embodiment, the request data may not include the decryption element. The processor can request transmission of the decryption element that is stored on the entity computer system upon receipt of a request.

In a step 312, the processor determines whether a threshold number of decryption elements have been received. If so, a step 314 decrypts the requested forecast data. Otherwise, a step 316 refuses to decrypt the forecast data. A step 318 sends the decrypted data to the requesters.

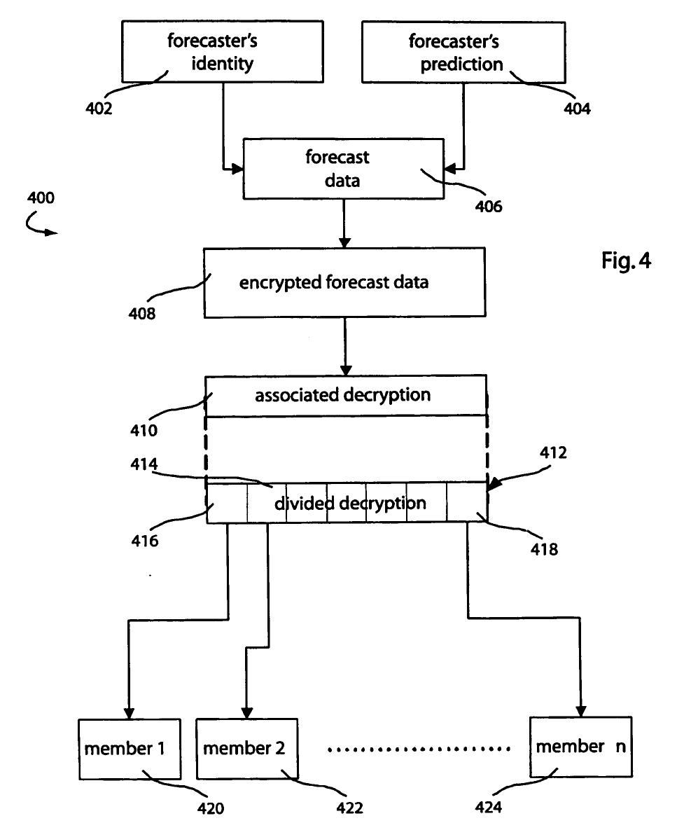

FIG. 4 represents a threshold cryptography process embodiment of the present invention, and is referred to herein by the general reference numeral 400. A forecaster's identity 402, and a forecaster's prediction 404, are associated by the processor and stored as forecast data 406. A step 408 encrypts the paired information. The encryption algorithm used is unlocked by a private key 410. Such is divided in a step 412, e.g., into constituent parts 414, 416, 418.

Individually, none of the constituent parts 414, 416, and 418, can be used to access any information regarding the identity of the forecaster or the other encrypted elements. However, when a threshold number of the constituent parts 414, 416, and 418, are available, the associated private encryption key 420 can be reconstructed and the forecaster's identity and prediction revealed. Each of the constituent parts 414, 416, and 418, is provided to, or associated with, a respective one of a production group member 420, 422, and 424.

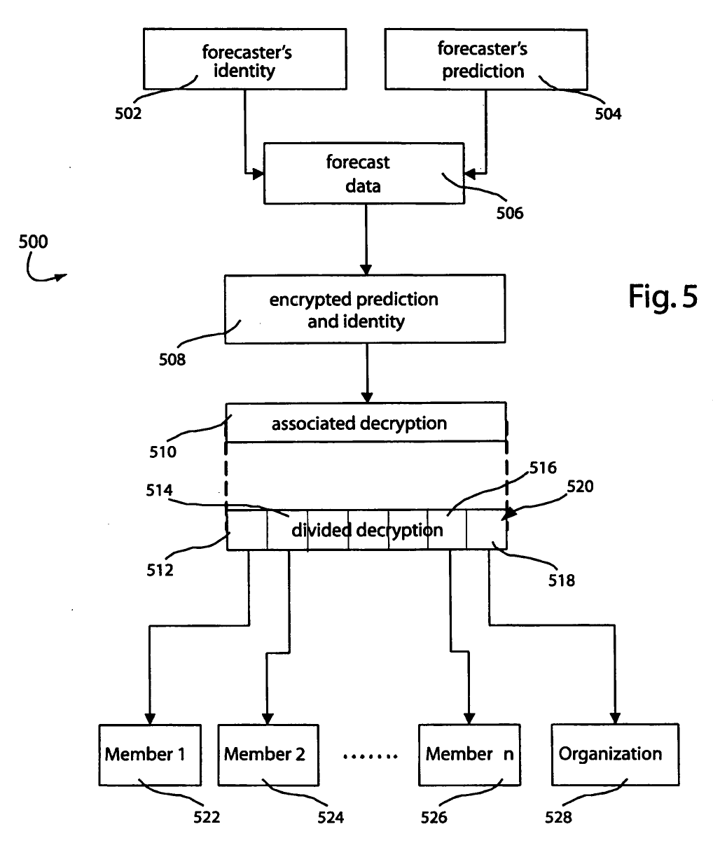

FIG. 5 represents a variation on process 400 (FIG. 4). The associated private encryption key is divided differently. The division method shown in FIG. 5 can advantageously be used with an identity escrow scheme such that the organization is given the opportunity to participate in the decision whether to reveal the forecast and identity of a suspicious forecaster. The organization alone is unable to decrypt a forecaster's identity. A minimum number of constituent parts of the private key are needed to be contributed by production group members. The division and distribution of the private encryption key can be such as to increase the number of key segments given to the organization. For example, to increase the ability of the organization to reveal the identity of a forecaster.

FIG. 5 represents a threshold cryptography process embodiment of the present invention, and is referred to herein by the general reference numeral 500. A forecaster's identity 502, and a forecaster's prediction 504, are associated by the processor and stored as forecast data 506. A step 508 encrypts the paired information. The encryption algorithm used is unlocked by a private key 510. Constituent parts 512, 514, 516, and 518, are divided up in a step 520.

Individually, none of the constituent parts 512, 514, 516, and 518, can be used to access any information regarding the identity of the forecaster or the other encrypted elements. However, when a threshold number of the constituent parts 512, 514, 516, and 518, are available, the associated private encryption key 510 can be reconstructed and the forecaster's identity and prediction revealed. Each of the constituent parts 512, 514, 516, and 518, is provided to, or associated with, a respective one of a production group member 522, 524, and 526, and importantly also to organization 528.

Once the forecaster's identity and forecast is revealed and any other associated information that has also been stored in relation to the forecast is reviewed it can be determined whether the particular person was actually acting against the interest of the organization or not.

In one method embodiment, all of the members of the production group must suspect a moral hazard for the suspicious forecast to be revealed, that is, the threshold number of members of the production group required to reveal a forecast is equal to the size of the production group. In this implementation the reconstitution of the private encryption key is relatively straightforward, with the only complicating factor being that a subgroup of the production group smaller than the whole must not be able to either ascertain the remaining parts of the private encryption key or otherwise decrypt the forecast data without all members providing their segment of the private encryption key.

In the embodiment a threshold cryptography algorithm is used that has the property that at least k members of the group of size n are required to reconstruct the private key and that any subgroups smaller than k individuals obtains no information at all about the key or the encrypted forecast data. In this example k<n.

Table II

A suitable method of key splitting is operates in the following manner.

1. The public key identifying an individual forecaster is expressed as a secret integer I, where I>0 and is distributed amongst the n members of the production group.

2. A prime p is chosen such that p>I and a coefficient aₒ is defined as a₀=I.

3. t−1 random, independent coefficients a₁, . . . aₜ₋₁ are selected such that 0≦aⱼ≦(p−1) to define a random polynomial f(x)=Σaⱼx^{j}.

4. Compute Iᵢ=f(i)modp, 1≦i≦n (or for any n distinct points i, 1≦i≦(p−1)). Each piece Iᵢ is securely transferred to a respective production group member Pᵢ along with the public index i.

5. Any group of t or more members of the production group can combine their pieces of the polynomial thus providing t distinct points (x,y)=(i,Iᵢ). Computing the coefficients aⱼ of f(x)where, 1≦j≦(t−1), using the Lagrange interpolation scheme. The secret identity can be recovered by noting that f(0)=a₀=I, that is the encrypted secret integer.

In such technique, the coefficients of an unknown polynomial f(x) of degree t defined by the set of points (xᵢ,yᵢ) where 1≦i≦t, are given by the Lagrange interpolation formula:

$$f ( x ) = {\sum }_{i = 1}^{n} {\prod }_{1 \leq j}^{} \frac{( x - {x}_{j} )}{( {x}_{i} - {x}_{j} )} .$$

Since f(0)=a₀=I, the secret identity I can be expressed as;

$$\begin{matrix}I = {\sum }_{i = 1}^{n} {c}_{i} {y}_{i} where , \\ {c}_{i} = {\prod }_{1 \leq j \leq t}^{} \frac{{x}_{j}}{( {x}_{j} - {x}_{i} )} .\end{matrix}$$

Thus the production group can compute I as a linear combination of t pieces yᵢ since the coefficients cᵢ are non-secret constants.

Thus, in this embodiment the decryption elements transmitted to or otherwise associated with each entity can take a variety of forms including the pieces of Iᵢ, a point (x,y)=(i,Iᵢ) on the curve or the coefficients aⱼ of f(x) In such a system even with infinite computational power it is not possible to learn anything more from the information provided to each individual than the length of the encrypted message. However, this does not represent a weakness in the security of the encrypted message as each of the members of the production group already knows the length of the encrypted message.

It is up to the organization to determine the level of privacy provided to its forecasters. In the present embodiment this takes the form of allowing the organization to set the threshold t that is the minimum number of individuals in the production group that must suspect a moral hazard in order to decrypt a forecaster's data.

Selecting the appropriate threshold by the organization will require a trade off between the rate of participation in the forecasting procedure and the likelihood of occurrence of a moral hazard situation. Strong privacy encourages participation but also facilitates and encourages moral hazards. Low levels of privacy discourage participation and the reporting of bad news, but also discourages moral hazards.

An organization can optimize the forecast data decryption threshold t. The organization can try various pilot systems with different thresholds and by observing the resulting participation levels and reported moral hazard situations then empirically select a threshold. A reasonable threshold could be determined by noticing the typical clique sizes within the production group and using this number as a lower bound on the threshold. Such a lower bound would make the individual forecasters feel that several independent decisions would need to be made in order to reveal their identity, thereby encouraging participation. The estimation of the clique size in the production group could be based on a wide range of observations or measures and may be determined by surveying staff members, or through estimations based on the organization's structure. In a particularly an method an individuals informal network or clique size may be revealed through web page linkages or in-house bulletin board or on-line chat-room participation analysis.

An upper bound on the threshold t may be determined by estimating how visible undesirable behavior is likely to be. In situations where undesirable behavior is almost undetectable by the production group a very low threshold should be set, whereas where it will be plain to the entire production group when a moral hazard situation has arisen and a forecaster is acting against the interest of the organization a high threshold can be set.

In certain organizations, one production group may include different subgroups, each with a different number of members. In such a production group a weighted threshold may be used, so that more people from larger subgroups are required, to decrypt a message and vice versa for a small subgroup. This allows certain flexibility in the identity escrow system to account for varying interaction groups within the production group.

In implementing the forecasting system the organization has a few design choices, e.g., the size of the payoff for correct prediction, the group size n over that participants forecast, and the extent of privacy of the forecasts.

The size of the payoff for correct prediction is the cost for running the forecasting system. Higher payoffs for accurate predictions encourage more participation in the forecasting system and encourage better predictions to be made.

Smaller groups allow more accurate prediction but make aggregation of forecasts more difficult. Moral hazards are also more likely to occur in smaller groups as individuals have more influence over the output of a small group.

Increased privacy encourages truthful reporting of bad news, however it also facilitates and encourages forecasters to engage in conduct that is to their own benefit but the organization's detriment.

For the individual, the choice between co-operating and defecting in relation to production is a choice between participating in production at an expected capacity, or producing below their expected capacity. In relation to forecasting a person is considered to co-operate if they participate accurately in the forecasting process. If they do not participate accurately in the forecasting process they are considered to defect on forecasting.

The choices made by the organization and individuals each have an associated cost and payoff. As will be explained below by appropriately selecting the parameters of the forecasting system including setting the levels of payoff for various outcomes the organization can optimize both participation in forecasting and production, thereby avoiding moral hazard situations.

The method of choosing a threshold that relies on Condorcet's theorem, states that if any individual has a probability of accurately detecting a detrimental action for the group, then it is possible to increase that probability by collectively aggregating them in a manner analogous to a majority vote. The winning threshold is not necessarily fifty percent.

Suppose a threshold t is selected, such that t out of a group of size n need to detect the moral hazard in order to reveal the forecast data under suspicion. Assume the members of the group made independent observations. The probability P(t,p) that the threshold reached is given by the upper tail of the binomial distribution;

$$P ( t , p ) = {\sum }_{i = t}^{n} ( \begin{matrix}n \\ i\end{matrix} ) {( 1 - p )}^{n - i} {p}^{i} .$$

This equation relates the probability of revelation of the forecast data to the chosen threshold, as well as the probability that members in the group will notice a moral hazard. The ideal situation is to find a threshold high enough so forecasters feel comfortable that their predictions are kept secret but not so high that they are enticed into a moral hazard situation and work against the organization.

Whether moral hazards will be detected depends on the ability of the production group members to discriminate between a situation in which a moral hazard has arisen and a situation when one has not. Take p₁ to be the probability that a production group member detects a problem with a forecaster, or otherwise chooses to act to reveal that person's forecast, when in fact the individual did not work against the organization, and take p₂ to be probability that a production group members detects a problem with the forecast, when a forecaster is actually working against the organization's interests. In most circumstances, p₂ would be greater than p₁ since it is reasonable to expect that an actual moral hazard is more detectable than a false moral hazard situation.

If the production group members have good ability to discriminate between members contributing to production and members defecting from production, then p₁ will be much less than p₂, and p2•1. On the other hand, if it is difficult for production members to discriminate between members contributing and members defecting then p₂ will only be slightly larger than p₁.

Using the formula for a given threshold t, P₁=P(t, p) and P₂=P(t, p₂). To calculate the optimum threshold and payoffs for the system, a simple equilibrium is assumed in which all of the production group members will participate in forecasting and in the production process. Therefore, three possible equilibrium states can arise, as in Table III.

TABLE III

members contribute to production but do not participate in
forecasting, e.g., f_{coop} = 1 and f_{forecast} = 0, where f is the
proportion of the group cooperating in either forecasting or
production. In this case, the forecasting system does not
function.
members contribute to production and participate in
forecasting, e.g., f_{coop} = 1 and f_{forecast} = 1.
members participate in forecasting but work against the
groups production, e.g., f_{coop} = 0 and f_{forecast} = 1. This situation
is the moral hazard outcome that the company seeks to avoid.

The ideal situation is that the production group attains equilibrium state “B”. By optimizing the payoffs and costs to the individuals the organization can ensure that equilibrium “B” is attained.

Each of the choices made by the organization and the individuals has a cost associated with it. For example if the individual chooses to defect on production their payoff in terms of profit share will decrease, whereas if they choose to co-operate on production their profit share for production will increase. Similarly in terms of forecasting co-operation is associated with a payoff offered by the company for accurate prediction whereas defection is not rewarded. If the organization has chosen to make the forecasting exercise public there is also a social cost (cₚ) for individuals in participating in the forecasting process and an extra cost “C” if a forecaster is found to be defecting on production e.g., is in a moral hazard situation. The individual's payoff U, can be expressed as U=U_{production}+U_{forecast}.

The payoff U for the individual in each of the possible permutations for cooperating and defecting on production and forecasting is set out in the following Table IV.

TABLE IV

| | | Forecast | |
|---|---|---|---|
| | | Cooperate | Defect |
| Production | Cooperate | M₋ − cₚP₁ + bf_{coop} − c | bf_{coop} − c |
| | Defect | M₊ − (cₚ + C)P₂ + b(f_{coop} − 1/n) | b(f_{coop} − 1/n) |

Where, M_{±} is the individual's payoff for participation in forecasting where

$${M}_{\pm } = \frac{A}{n} ( 1 + \pm α ) .$$

The plus sign represents the situation where the individual's production and forecasting choices match, and the minus sign represents the situation where they do not.

A is the individual's payoff set by the organization for accurate forecasting.

n is the number of members in the production group.

• represents the difference in accuracy in forecasting between the M+ and M− states 0, ••<1.

c is the cost for cooperating on production.

cₚ, “C”, P₁ and P₂ are as defined above.

The organization's choices when implementing the system that are aimed at achieving equilibrium “B” include choices for the threshold t, the payoff for accurate forecasting “A”, and the penalty “C” when individuals are identified as working against the organization.

To encourage participation the payoff “A” should be sufficiently large. On the other hand, to effectively prevent moral hazards the penalty must also be correspondingly large, thus we take “C” to be proportional to “A”. Where “γ” is the constant of proportionality between the payoff and penalty e.g., C=γA. Given these constraints the equilibrium state is determined by calculating that of the expressions set out in the table above provides the largest payoff to the individuals in the production group.

In order to demonstrate a set of suitable parameters for a forecasting system two situations will now be contrasted. In the first situation the parameters for the expressions set out in the table above are as follows, n=10, p₁=0.1, p₂=0.6, •=0.5, cₚ=1.0, c=3, γ=0.2 and b=10

FIG. 6 plots the equilibrium regimes for these parameters as the threshold t and payoff “A” vary. All three equilibrium states “A”, “B” and “C” are present.

The organization may select a suitable threshold t and payoff “A” such that the forecasting mechanism operates within the type “B” equilibrium state. All members of the production group contribute effectively to production and forecasting.

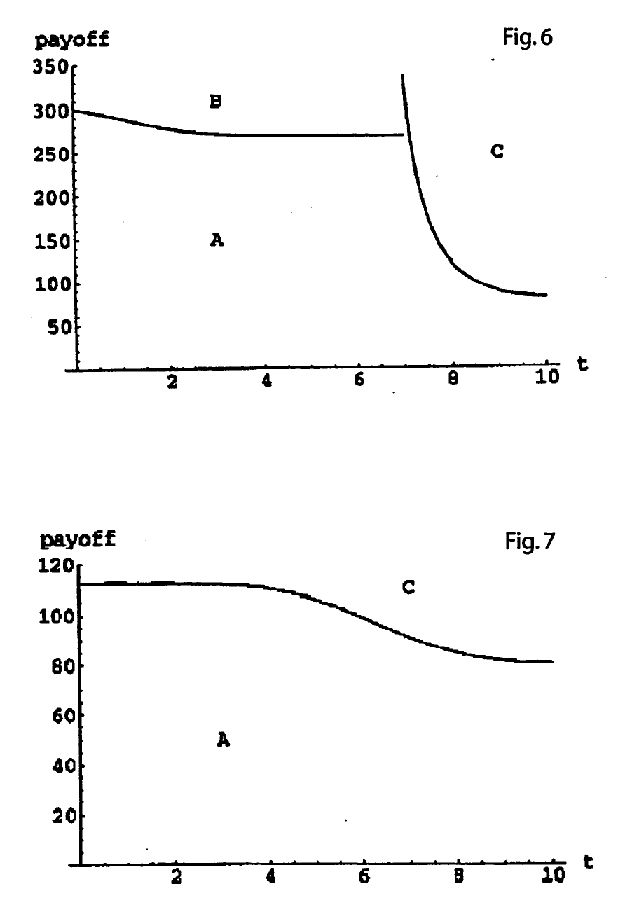

FIG. 7 shows the equilibrium situations that arise when an alternative set of parameters are used, n=10, p₁=0.1, p₂=0.6, •=0.5, cₚ=1.0, c=3, γ=0.02 and b=10. The equilibrium regimes are calculated in the same manner that was used to generate FIG. 6. Equilibrium state “B” is never reached and as such there is no equilibrium state in which both forecasting and advantageous production occurs.

Thus, the choices made by the organization in setting payoffs for cooperation on forecasting and production as well as the threshold value t can be used to ensure that the implementation of the methodology is successful in which both effective production and accurate predictions are generated.

In broad concept the present invention uses identity escrow to encourage participation in forecasting, by providing anonymity whilst also allowing for the revelation of a participant's identity if certain predetermined circumstances arise.

The above-described embodiment of the invention may also be implemented, for example, by operating a computer system to execute a sequence of machine-readable instructions. The instructions may reside in various types of computer readable media. In this respect, another aspect of the present invention concerns a programmed product, comprising computer readable media tangibly embodying a program of machine-readable instructions executable by a digital data processor to perform the method in accordance with an embodiment of the present invention.

This computer readable media may comprise, for example, RAM contained within the system. Alternatively, the instructions may be contained in another computer readable media such as a magnetic data storage diskette and directly or indirectly accessed by the computer system. Whether contained in the computer system or elsewhere, the instructions may be stored on a variety of machine readable storage media, such as a DASD storage (for example, a conventional “hard drive” or a RAID array), magnetic tape, electronic read-only memory, an optical storage device (for example, CD ROM, WORM, DVD, digital optical tape), or other suitable computer readable media including transmission media such as digital, analog, and wireless communication links. In an illustrative embodiment of the invention, the machine-readable instructions may comprise lines of compiled C, C++, or similar language code commonly used by those skilled in the programming for this type of application arts.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

What is claimed is:

1. A forecasting system, comprising:
a plurality of forecasters that provide predictions and that have individual identities;
a plurality of users that depend on receiving said predictions from the plurality of forecasters and that use forecasts assembled wherefrom to manage a business organization;
an encryption system for encoding and hiding said individual identities of each of the plurality of forecasters and for encouraging more honest predictions; and
a decryption system for decoding and revealing said individual identities of each of the plurality of forecasters and for discouraging moral hazards in said predictions;
wherein said individual identities of each of the plurality of forecasters are encrypted, associated, and embedded with their respective predictions.

2. The forecasting system of claim 1, further comprising:
a private key parser for distributing constituent parts of a private encryption key used by the encryption system to individual ones of the plurality of users;
wherein a private encryption key reconstituted from said constituent parts is required by the decryption system to decode and reveal said individual identities of any of the plurality of forecasters.

3. The forecasting system of claim 1, further comprising:
a private key parser for distributing constituent parts of a private encryption key used by the encryption system to individual ones of the plurality of users;
wherein a private encryption key reconstituted from less than all of said constituent parts is required by the decryption system to decode and reveal said individual identities of any of the plurality of forecasters.

4. The forecasting system of claim 1, further comprising:
a private key parser for distributing constituent parts of a private encryption key used by the encryption system to individual ones of the plurality of users and to an organization;
wherein a private encryption key reconstituted from less than all of said constituent parts is required by the decryption system to decode and reveal said individual identities of any of the plurality of forecasters.

5. The forecasting system of claim 1, further comprising:
a private key parser for distributing constituent parts of a private encryption key used by the encryption system to individual ones of the plurality of users; and
a network for interconnecting the plurality of forecasters, plurality of users, the encryption system, and the decryption system;
wherein a private encryption key reconstituted from said constituent parts is required by the decryption system to decode and reveal said individual identities of any of the plurality of forecasters.

6. A method of forecasting, comprising:
generating predictions from forecasters;
concealing the identities of individual ones of said forecasters to encourage candid forecasts;
bundling said predictions with an encryption of said corresponding identities of individual ones of said forecasters into a forecast data;
forwarding said forecast data to a plurality of users; and
decrypting said corresponding identities of individual ones of said forecasters from said forecast data if a predetermined number of said users request such action.

7. The method of claim 6, further comprising:
parsing a private encryption key into constituent parts;
distributing said constituent parts to individual ones of said users; and
collecting from said users their respective ones of said constituent parts of said private encryption key when each user requests that said identity of an individual one of said forecasters be revealed; and
revealing said identity of an individual one of said forecasters if a predetermined minimum number of said constituent parts has been collected.

8. A computer program product for implementing a method of forecasting, the computer program product comprising a computer usable medium having computer readable program means for causing a computer to perform the steps of:
generating predictions from forecasters;
concealing the identities of individual ones of said forecasters to encourage candid forecasts;
bundling said predictions with an encryption of said corresponding identities of individual ones of said forecasters into a forecast data;
forwarding said forecast data to a plurality of users; and
decrypting said corresponding identities of individual ones of said forecasters from said forecast data if a predetermined number of said users request such action.

9. The computer program product of claim 8, the steps further comprising:
parsing a private encryption key into constituent parts;
distributing said constituent parts to individual ones of said users; and
collecting from said users their respective ones of said constituent parts of said private encryption key when each user requests that said identity of an individual one of said forecasters be revealed; and
revealing said identity of an individual one of said forecasters if a predetermined minimum number of said constituent parts has been collected.
